(19) United States
(12) Patent Application Publication
(10) Pub. No.: US 2005/0273321 A1
(43) Pub. Date: Dec. 8, 2005

(54) Audio signal time-scale modification method using variable length synthesis and reduced cross-correlation computations

(76) Inventor: Won Yong Choi, Gyeonggi-do (KR)

Correspondence Address: NIXON PEABODY, LLP, 401 9TH STREET, NW, SUITE 900, WASHINGTON, DC, 20004-2128, US

(21) Appl. No.: 10/523,923

(22) PCT Filed: Aug. 8, 2002
(86) PCT No.: PCT/KR02/01499

§ 371 Date: Feb. 7, 2005

(51) Int. Cl. G10L 11/04

(52) U.S. Cl. 704/207

(57) ABSTRACT

Disclosed is an audio signal time-scale modification which utilizes variable length synthesis for the improvement of output audio quality and reduced cross-correlation computations for the reduction of computation loads to a processor. An analysis window consisting of N+Kmax audio samples is selected from an input audio samples and is shifted by the predetermined interval along output audio samples to find optimal shift Km, which ensures best cross-correlation between Nov audio samples of the analysis window and last Nov audio samples of the output audio samples and a particular value of Nm at which a coefficient of correlation between them is larger than a reference value or is the maximum one among a plurality of coefficients of correlation calculated with varying the value of Nov. The audio samples involved in the calculation of cross-correlation are down-selected by the predetermined ratio from Nov audio samples of the analysis window and last Nov audio samples of the output audio samples, respectively. The analysis window may also be shifted by the plurality of audio samples per one shift. The audio samples ranged region (Km+Nov−Nm)^{th} sample in the analysis window is determined as an add frame. The existing last Nm audio samples of the output audio samples are replaced with new Nm audio samples obtained by weighting and adding the overlapped parts, i.e., the first Nm audio samples of the add frame and the last Nm audio samples of the output audio samples, while remaining part of the add frame is simply appended to the tail of the new Nm audio samples in the output audio samples.

### TECHNICAL FIELD

The present invention relates to a technique for time-scale modification (“TSM”) of an audio signal and, more particularly, to a method which allows in a time-domain a real-time modification of an original audio signal of which sampling rate is high and minimizes distortion of pitch information of the original input audio signal.

### BACKGROUND ART

In order to reproduce an audio signal such as voice, music or mixture of several kinds of sounds at a non-normal playback speed that is slower or faster than a normal playback speed, it is necessary to modify a time-scale of the audio signal. An audio signal time-scale modification method can roughly be classified into a frequency-domain processing method and a time-domain processing method. Since the frequency-domain processing method uses a fast Fourier transform (“FFT”) and requires a large amount of computation, the method has lots of difficulties in its implementation and is in general considered unsuitable for an application field requiring a real-time processing. In comparison with the frequency-domain processing method, the time-domain processing method requires a relatively small amount of computation to provide a sound of good quality and thus is considered suitable for such a real-time application field.

The basic concept of the time-domain processing method was introduced in the name of an overlap-add (“OLA”) method. According to the OLA method, an input audio signal is segmented into a plurality of partially overlapped frames and an interval (i.e., time) between adjacent frames is modified according to a desired time-scale, where every the time-scale modified input frame is added in turn to an output audio signal. When adding the frame to be added to the out audio signal, the overlapped parts of the frame to be added and the output audio signal are added by applying a weighting function to both party and non-overlapped part of the frame is added as it is. Since the introduction of the OLA method, there have been introduced various improved methods, such as a synchronized overlap-add (“SOLA”) method and a waveform similarity based overlap-add (“WSOLA”) method, focused on reducing the amount of computation and making the quality of sound of a TSM-processed audio signal more similar to that of an input audio signal.

The SOLA method modifies the time-scale of an input signal by the two steps referred to as analysis and synthesis. Similar to the OLA method, the analysis step does the process of segmenting an input signal into a plurality of partially overlapped windows, each of which has a fixed length N and is spaced by a fixed analysis shift Sa. The synthesis step does the process of re-aligning the windows obtained at the analysis step by a synthesis shift Ss. At this time, each window is partially overlapped with an output signal that is made by the synthesis of previous windows. When overlapping with the output signal, each such window is so aligned at a position where a similarity, i.e., cross-correlation to the output signal is maximum as to reduce the signal discontinuities caused by the difference between the analysis shift Sa and the synthesis shift Ss. Such an overlap by the above alignment is referred to as a synthesized overlap. Following processes applied to the synthesis of the overlapped parts and the simple addition of the non-overlapped part are almost identical to the OLA method. As the SOLA method modifies a time-scale in a manner that original pitch information is maintained at a maximum degree, it improves the sound quality of the time-scale modified output signal more than the OLA method does. However, the SOLA method has a problem that, during which the maximum similarity position is searched, an aligning position Km keeps changing and the overlapped parts thereby vary, so that a new cross-correlation should be calculated and this complicated calculation results in requiring a large amount of computation. Hence, the SOLA method is not suitable for applications which need real time processing. Moreover, it fails to provide a way that the ratio of signal length between an input signal and a time-scale modified output signal becomes exactly identical with a desired time-scale value.

The WSOLA method is a method that finds the maximum cross-correlation position on the basis of waveform similarity of adjacent frames to sufficiently secure continuities of a signal at a boundary of waveform segments and, in particular, makes a synthesis signal of which the time-scale has been modified in all neighboring samples of a related sample index have a maximum local similarity with an original signal. Although the WSOLA method makes less frequency distortion and requires a less amount of computation than the SOLA method, reducing the amount of computation is restricted in that a short time Fourier transform (“STFT”) should be adopted to find a waveform similarity. Hence, the WSOLA method cannot easily be utilized in an application field that time-scale modification should be handled in a way of real-time process.

One of the most important factors that should be taken into account in respect of time-scale modification of an audio signal is to reduce the amount of computation. If the amount of computation is large, application areas are greatly restricted because real-time process of the TSM is impossible. When a particular window (or frame) of an input signal is overlap-and-added with an output signal, the TSM time-domain processing methods such as SOLA, WSOLA and their other modified methods find a position which provides the maximum value of a cross-correlation between the window and a time-scale modified signal (hereinafter referred to as “output signal”) and synthesize the window and the output signal at the position so as to make the output signal be identical to a maximum degree to an original signal (hereinafter referred to as “input signal”) in respect of spectral characteristics or pitch period of an audio signal. However, finding the position which provides the maximum value of the cross-correlation causes a large amount of computation. When TSM is processed according to the prior methods, more than 95% or so of the loads imposed on a processor (or CPU) is generated in the process of finding the maximum value position of the cross-correlation.

Moreover, the amount of computation relating to cross-correlations increases in geometric progression as a sampling rate of an input signal for TSM process becomes high. The reason is that calculating the maximum cross-correlation value requires a double loop computation and the amount of computation for each loop is proportional to the sampling rate of the input signal. That is, the double loop has a first loop which multiplies in a way of one to one all samples belonging to a certain part (an overlap part) of an analysis window of the input signal and all samples of a certain part (an overlap part) of the output signal and a second loop which recursively carries out the multiplying computation of said first loop while shifting said analysis window by one sample with respect to a search range. The amount of computation of each loop is almost proportional to the sampling rate of the input signal. As the two loops are executed in a double loop manner, the increase pattern of the computation amount is exponentially proportional to the sampling rate of the input signal. Therefore, even the WSOLA method known as requiring a less amount of computation than the SOLA and other methods requires a large amount of computation, so that it may be applicable to a personal computer equipped with a CPU of good performance, but not applicable to a system equipped with an embedded processor of relatively poor performance.

With respect to a 20 ms packet (segment) of an audio signal sampled at 8 KHz, the prior TSM methods according to the above-mentioned double loop computation manner should perform multiplication of 24,000 times and addition over 24,000 times. It takes about 0.35 ms to perform the TSM computation by a 773 MHz Intel Pentium III chip with respect to the 20 ms packet of an audio signal of an 8 KHz sampling rate. In case of an audio signal of a 44.1 KHz sampling rate, the TSM computation by the 773 MHz Intel Pentium III chip with respect to the 20 ms packet requires approximately 10.64 ms. Therefore, such TSM computations require the CPU capacity above 389 MHz, which means at least the whole processing capacity of the 389 MHz CPU should be allocated to the TSM computations. On the other hand, it is impossible for even the 773 MHz Intel Pentium III processor to perform the TSM computation for a DVD audio signal of a 96 KHz sampling rate in real-time because the TSM computation for this signal approximately takes 50.4 ms per 20 ms packet (segment). To perform the TSM for an audio signal sampled at 44.1 KHz by the ordinary SOLA or WSOLA method, at least the whole processing capacity of a 389 MHz embedded type processor should be allocated to the TSM computation. In the case of an audio signal of a 16 KHz sampling rate, the processing capacity of at least 51 MHz should be allocated to the TSM computation. Taking account of the following aspects that the best performance of commercialized embedded processors cannot go beyond 200 MHz yet and that the loads imposed on an embedded processor are not only for the TSM processing but also for other service processing in a system for which the embedded processor is adopted, it is, in reality, almost impossible to process the TSM with respect to an audio signal having a sampling rate higher than 8 KHz in real-time by using an embedded processor in which a program according to the prior TSM methods is installed.

In particular, the recent trend reflecting consumers' demand on high quality sound is that the sampling rate of an audio signal has gradually become higher. In recent years, a WAV format usually used in personal computers as well as an MPEG monotype have mainly used a sampling frequency of 44.1 KHz. Further, the sampling rate of 96 KHz or 192 KHz which is almost double 96 KHz is used for DVDs. To process the TSM with respect to an audio signal of a high sampling rate in real-time, it is necessary to reduce the amount of computation within the range of processing capacity that the processor can allocate. The known TSM methods cannot suggest any solutions to the above need.

As long as the amount of computation for the TSM can be remarkably reduced, part of a processor's surplus capacity obtained from the reduction can be transferred for improving the quality of sound to obtain a sound of better quality than before. As voices do not have a wide frequency bandwidth, the conventional TSM methods synthesizing the voice signals based on the maximum value of cross-correlation do not greatly distort pitch information of an original voice. However, in the case of music having a relatively wide frequency bandwidth, an output signal processed by the conventional TSM methods has a relatively large degree of distortion in pitch information and noises. Hence, music signals require additional processing for improving the sound quality of a time-scale modified output signal.

### DISCLOSURE OF INVENTION

In respect of time-scale modification of an audio signal in time-domain processing, it is a first object of the present invention to provide a method capable of remarkably reducing the amount of computation for searching a maximum value of cross-correlation and capable of performing in real-time the TSM processing with respect to an audio signal of a high sampling rate.

It is a second object of the present invention to provide a method for making pitch information of an output signal be more close to that of an input signal by determining an overlap position of an analysis window and a size of an overlap-add region between the analysis window and the output signal by taking account of an evaluation index, coefficient of correlation, in addition to a cross-correlation when the analysis window determined in the input signal is overlap-added to the output signal.

According to the present invention, there is provided a method for time-scale modification of an audio signal by which an input signal comprised of an input stream of audio samples is converted into an output signal modified at a desired time-scale, comprising the steps of: determining an analysis window consisting of a first predetermined number of audio samples in said input stream; repeating a computation of a similarity between Nov first audio samples of said analysis window and Nov second audio samples of said output signal whenever said analysis window is shifted within a predetermined search range, said similarity being calculated using third and fourth audio sample blocks consisting of audio samples down-selected from said first and second audio samples at a predetermined rate, respectively; and obtaining a shift value Km of said analysis window when a maximum value of the calculated similarity is provided.

It is preferable that the above method for time-scale modification of an audio signal further comprises the step of determining N+Nm−Nov audio samples as an add frame based upon the shift value Km and an optimal overlap length Nm at the time that a coefficient of correlation between said analysis window and said output signal is above a predetermined threshold value or provides a maximum value, said N being a value that a similarity search range Kmax between said analysis window and said output signal is deducted from said first predetermined number.

It is more particularly preferable that the above method for time-scale modification of an audio signal further comprises the steps of: forming an overlap-add block by weighting Nm audio samples from the beginning of said add frame and Nm audio samples from the end of said output signal with a weighting function; and substituting said overlap-add block for said Nm audio samples from the end of said output signal and adding the rest audio samples of said add frame to the end of said overlap-add block as they are.

To accomplish the second object of the present invention, there is provided a method for time-scale modification of an audio signal by which an input signal comprised of an input stream of audio samples is converted into an output signal modified at a desired time-scale, comprising the steps of: determining an analysis window consisting of N+Kmax audio samples in said input stream, where said N and said Kmax are constants; while shifting said analysis window within a predetermined search range, computing a maximum value of a similarity between Nov audio samples of said analysis window and Nov audio samples from the end of said output signal and values of coefficient of correlation therebetween with changing said value Nov into various values; determining N+Nm−Nov audio samples from a Km+Nov−Nm^{th} audio sample from the beginning of said analysis window as an add frame, where said Km is a shift value of said analysis window when said maximum value of said similarity is provided, said Nm being an optimal overlap length when a coefficient of correlation between said analysis window and said output signal is above a predetermined threshold value or provides a maximum value, and said N being a value obtained when N+Kmax is deducted by a similarity search range Kmax between said analysis window and said output signal; forming an overlap-add block by weighting Nm audio samples of said optimal overlap length from the beginning of said add frame and Nm audio samples of said optimal overlap length from the end of said output signal with a weighting function; and substituting said overlap-add block for said Nm audio samples of said optimal overlap length from the end of said output signal and simply adding the rest audio samples of said add frame to the end of said overlap-add block.

In the method of the present invention provided for accomplishing the first or second object, said audio samples consisting of said third and fourth audio sample blocks have a difference in sample index as much as M₁ which is a natural number bigger than 2. Also, said first predetermined number has a value of N+Kmax, where N and Kmax are constants, and said search range consists of Kmax audio samples. Said analysis window is shifted by M₂ audio samples per one time shift, where M₂ is a natural number bigger than 2. It is preferable that said similarity is determined by the computing of a cross-correlation.

### BRIEF DESCRIPTION OF DRAWINGS

FIG. 1A is a view for illustrating a method of determining the position of the maximum cross-correlation between an output signal and an analysis window of an input signal while shifting the following analysis window, according to a TSM method of the present invention which is referred herein to as reduced computations and variable synthesis based TSM (“RCVS-TSM”).

FIG. 1B is a view for illustrating a method of determining and synthesizing overlapped parts between the output signal and the analysis window of the input signal, according to the RCVS-TSM method of the present invention.

FIG. 2 is a view for illustrating a method of computing a cross-correlation with respect to the overlapped parts between the analysis window of the input signal and the output signal, according to the RCVS-TSM method of the present invention.

FIG. 3A illustrates a method of determining an analysis window in an input signal where the desired time-scale is 2 (α=2).

FIG. 3B illustrates a method of synthesizing an output signal by overlap-adding the analysis windows determined in FIG. 3A to an existing output signal based on the determined maximum cross-correlation and overlap length.

FIG. 4A illustrates a method of determining an analysis window in an input signal where the desired time-scale is 0.5 (α=0.5).

FIG. 4B illustrates a method of synthesizing an output signal by overlap-adding the analysis windows determined in FIG. 4A to an existing output signal based on the determined maximum cross-correlation and overlap length.

FIG. 5 is a flow chart for illustrating overall procedures for performing the RCVS-TSM method according to the present invention.

FIG. 6 is a flow chart for illustrating detailed procedures of step S18 (the step of determining the maximum value of cross-correlation and a shift value of the analysis window at that time) of the flow chart illustrated in FIG. 5.

FIG. 7 is a flow chart for illustrating detailed procedures of step S20 (the step of determining an overlap length based upon a coefficient of correlation between the analysis window and the output signal) of the flow chart illustrated in FIG. 5.

FIG. 8 is a block diagram of an apparatus equipped with necessary resources for performing the method of the present invention.

### BEST MODE FOR CARRYING OUT THE INVENTION

Hereinafter, the preferred embodiments of the present invention will be explained in detail with reference to the accompanying drawings.

An input signal means an original audio signal which is an object of TSM processing, and an output signal means an audio signal obtained from the TSM processing. The input signal is formed as a stream of sample signals obtained by sampling and quantizing an analog audio signal.

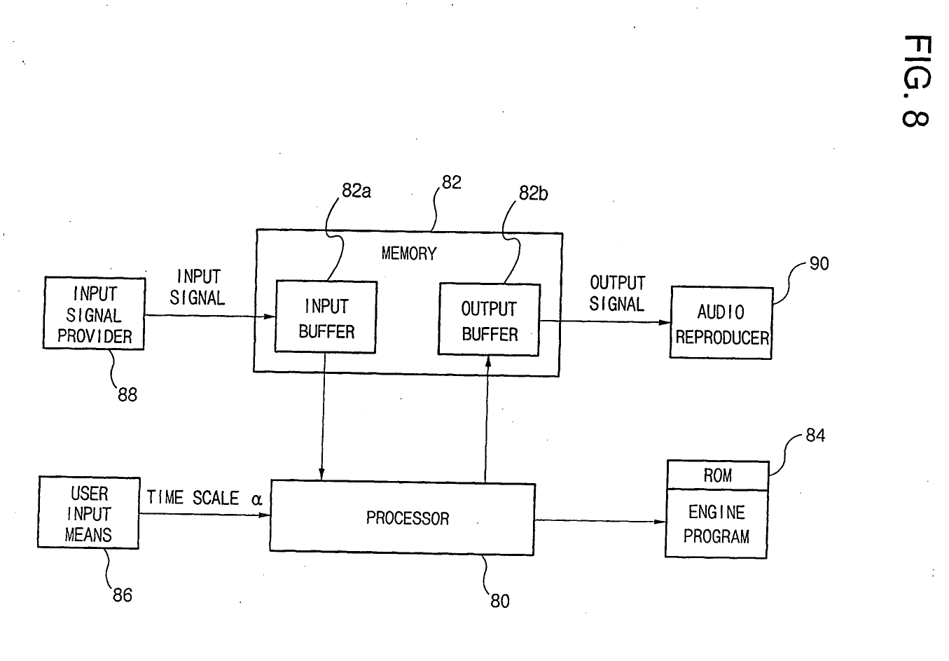

Various processing explained below is performed in a manner that makes an engine program based on the RCVS-TSM algorithm and then performs the engine program by a processor. Accordingly, an apparatus for performing the present invention as illustrated in FIG. 8 basically requires a non-volatile memory 84, such as ROM device for storing the engine program, a processor 80 for performing TSM processing of an input signal by reading the engine program to perform each command word in turn, and memory resources 82 for providing a data processing space of the processor 80 such as an input buffer memory 82a for temporarily storing an input signal before TSM processing and an output buffer memory 82b for temporarily storing a post-TSM processing output signal. In addition, in order to receive a time-scale value designated by the user and to perform TSM processing according to the designated value, required are such means as a user input means 86 (for example, an input keypad or a remote control) for allowing the user to designate a time-scale value, i.e., a desired playback speed of an audio signal and for reading-in the designated time-scale value to reflect in TSM processing, by the processor 80, made after the reading-in. Further, it is necessary for the apparatus to have an input signal provider 88 for providing an input signal, which is an object of TSM processing, to the input buffer 82a for TSM processing and an audio reproducer 90 for performing signal processing necessary for audio reproduction to the output signal obtained as a result of TSM processing from the output buffer 82b.

Each of those resources can exist as an independent chip as in the case of a personal computer, or may be integrated into one or several chips. Therefore, unless specified, it can be understood that the above resources function and perform in common RCVS-TSM processing as explained below. The processor 80 can be embodied by, for example, a digital signal processor (DSP), a microcomputer or a central processing unit (CPU), or by such chips made for specific purposes as an audio chip, an audio/video chip, an MPEG chip, a DVD chip and so on.

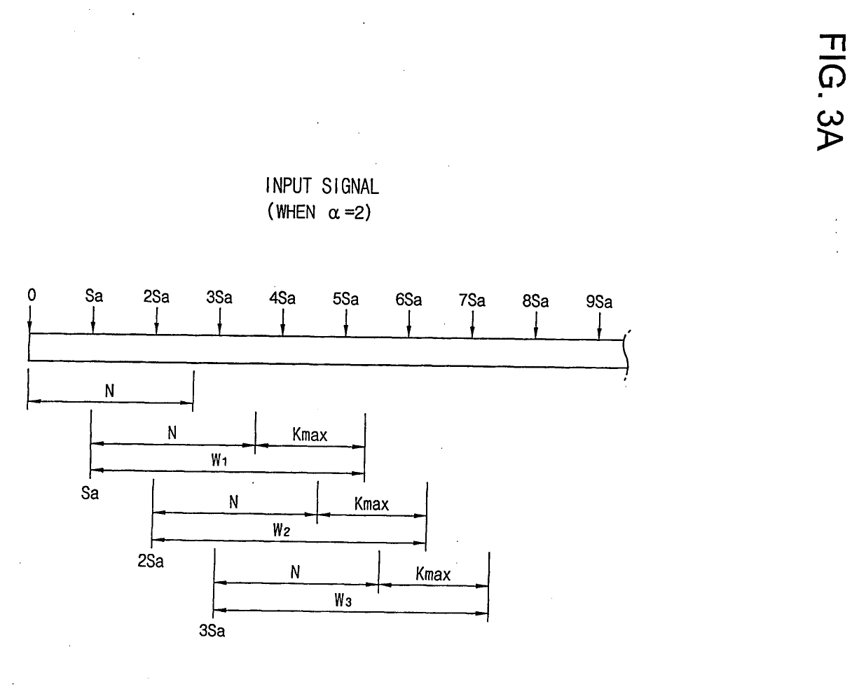

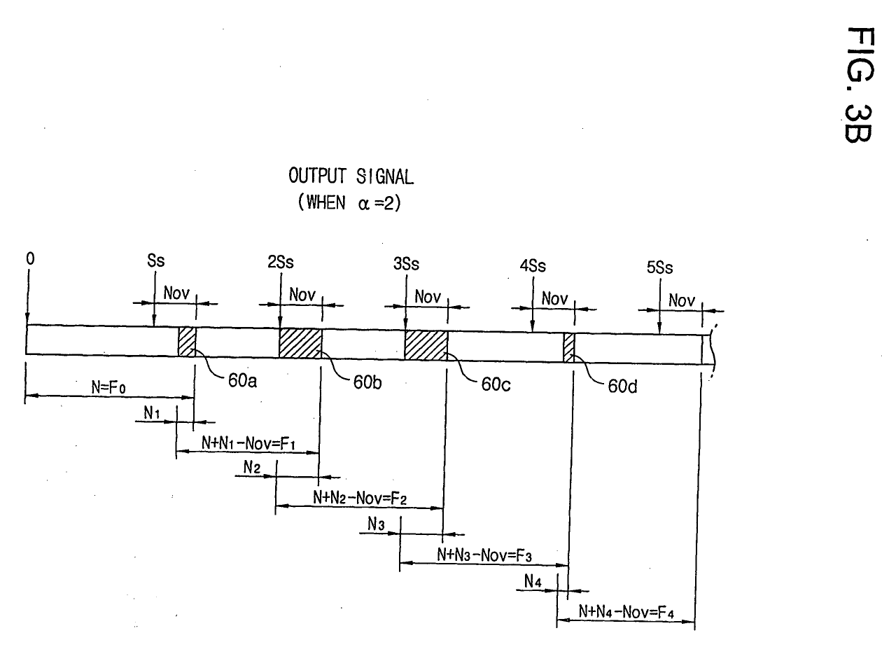

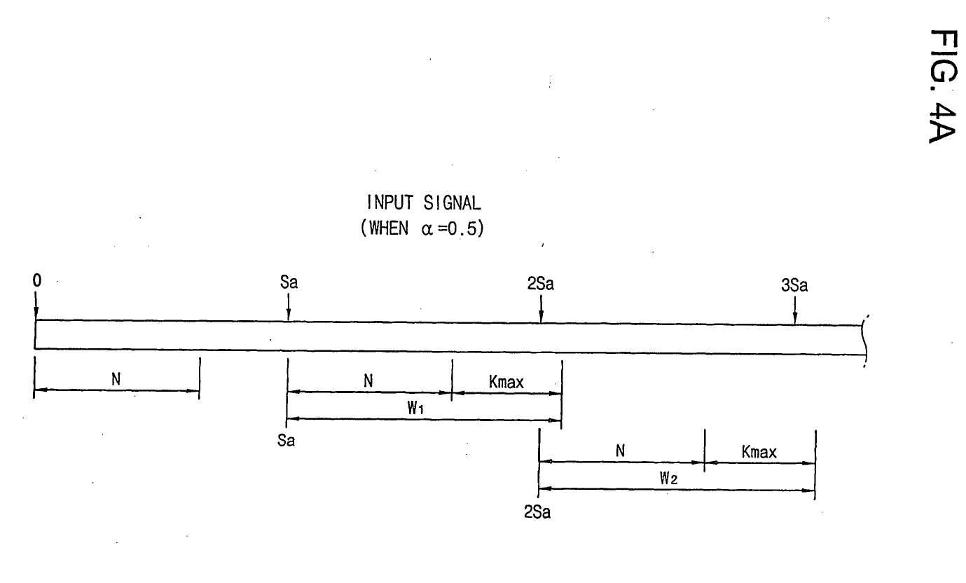

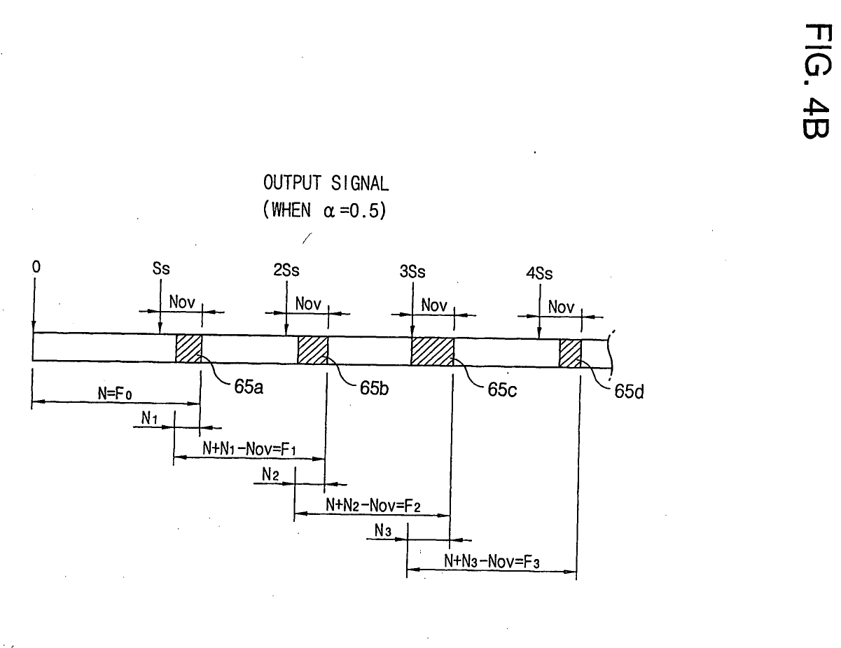

The RCVS-TSM method of the present invention by large consists of analysis processing and synthesis processing. Referring to FIG. 3A or 4A, the input signal is segmented by successive analysis windows Wm (m=1, 2, 3, . . . ) and each analysis window, consisting of the N+Kmax number of samples, is a unit of analysis for RCVS-TSM. The starting position of each analysis window Wm becomes the mSa^{th} sample from the input signal. Therefore, Sa means a starting position interval (hereinafter referred to as “analysis interval”) of successive analysis windows. Herein, m denotes a frame index and N denotes the number of samples of one reference frame F₀. To find a point that provides the maximum cross-correlation between the analysis window and an output signal (or time scale modified signal), the analysis window Wm reverse shifts by the constant sample interval M₂ per shift period along the time scale modified signal. The shift of the analysis window Wm is made within the range of the Kmax number of samples. Kmax denotes the maximum value of the number of samples shifting the analysis window, i.e., a search range for analyzing a position which provides the maximum value of cross-correlation. The best shift Km of the analysis window Wm denotes a distance that the analysis window Wm is shifted to the position that the maximum value of cross-correlation is provided, i.e., the number of shifting samples. The value of Km cannot exceed Kmax.

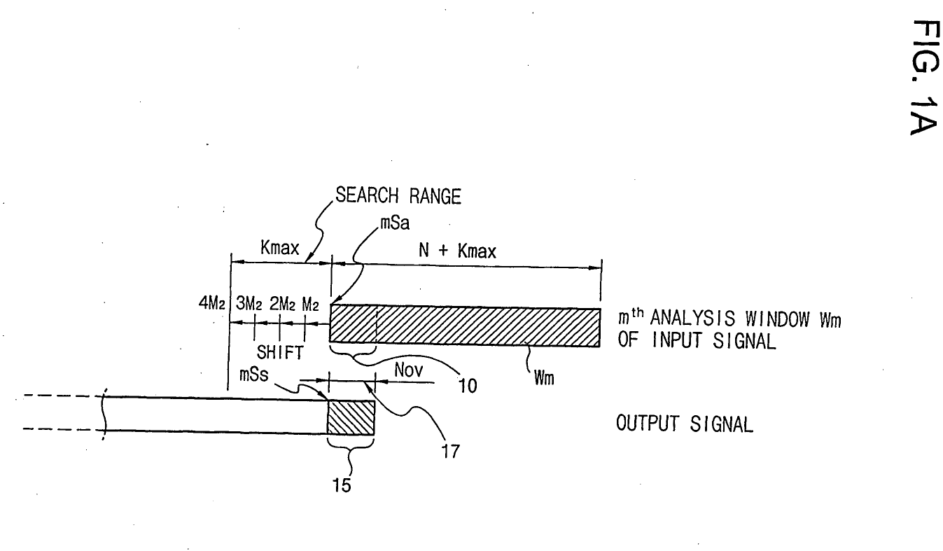

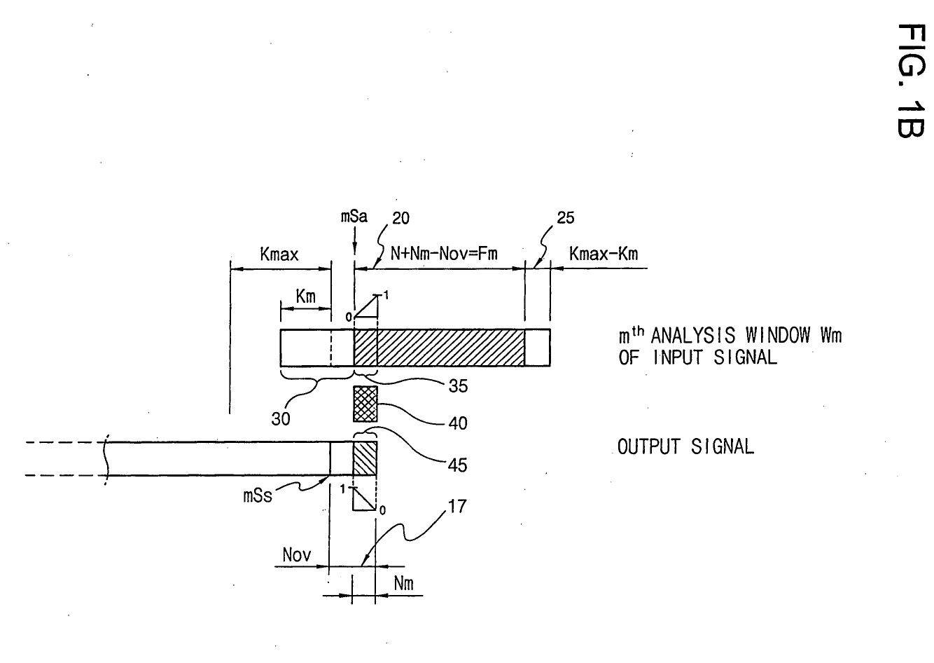

Referring to FIGS. 1A and 1B, when the analysis window Wm is synthesized to the time scale modified (TSM) signal as an output signal, the synthesis interval Ss becomes a reference. The synthesis interval Ss has a relation of ‘Ss=αSa’ with the analysis interval Sa. The synthesis interval Ss is a fixed value. Therefore, when the desired time-scale value α is given, the value of the analysis interval Sa is determined by the above equation. The synthesis interval Ss becomes a starting position of the shift for searching the maximum value of cross-correlation between the analysis window and the time scale modified signal. That is, computation for obtaining the maximum value of cross-correlation is started by positioning the beginning of the analysis window Wm in the mSs^{th} sample position of an output signal. Synthesis adds each analysis window Wm by overlapping with part of an output signal at the position of the maximum cross-correlation found in the analysis step. At this time, the value of the overlap interval is varied into several values when the cross-correlation between the analysis window Wm and the time scale modified signal, and an overlap interval which corresponds to a case that a predetermined condition is satisfied is determined as an overlap interval Nm to be actually applied. To easily embody a program, it is preferable that the value of the overlapped interval is changed in a manner that from the maximum value of Nov the value is reduced by the constant rate or interval. When the overlap interval Nm are determined, an add frame 20 is determined in the analysis window Wm. After a new synthesis block 40 is made by adding the Nm number, from the end of the output signal, of samples 45 and the Nm number, from the beginning of the add frame 20, of samples 35 under the application of a weighting function. The new synthesis block 40 is converted into the output signal as a substitute for the existing samples 45 of the output signal, and the rest samples of the add frame 20 are simply added after the new synthesis block 40 as the output signal.

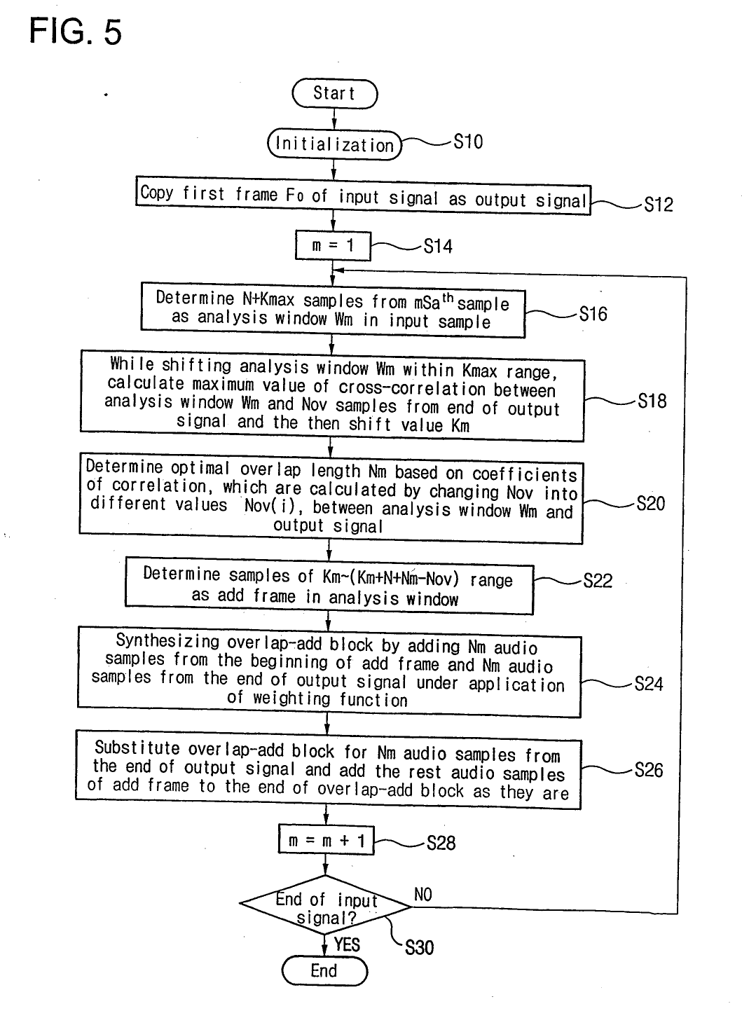

The flow chart of FIG. 5 roughly illustrates overall implementation procedures of RCVS-TSM algorithm of the present invention based on this basic concept. The RCVS-TSM algorithm starts with finding necessary information for reproduction with reference to information recorded in a header of the input signal and performing various initialization necessary for RCVS-TSM processing (step S10). As basic information concerning the audio input signal such as a sampling rate and a sampling size is recorded in the header of the input signal, sampling rate information can be utilized for reducing the amount of computation for finding the maximum cross-correlation point. The more detailed explanation regarding this is provided later. In the initializing step, the following various parameters are initialized. First, suitable values are given to parameters N, Nov, Ss, Kmax and so on. In particular, if the value of Kmax is large, the quality of sound of a TSM-processed signal becomes better. However, as the value of Kmax increases, the degree that the quality of sound becomes better is saturated but the amount of computation gradually increases. Therefore, it is preferable that the value of Kmax is properly selected at around the point that the improvement degree of sound quality becomes slow. If a desired time-scale value α is given, determining the value of Sa by using the equation Sa=Ss/α is required at the initializing step.

After the initialization, the first thing to do is to copy the first N number of samples of the input signal as an output signal as they are. The N number of copied samples consists of the first frame F₀ of an output signal (step S12). As processing with respect to one frame has been done, the value of frame index m is set to 1 (step S14).

TSM processing with respect to the input signal is carried out by repeatedly performing a loop consisting of steps S16˜S28 until the end of the input signal is met and by increasing the value of frame index m by one. Whenever this loop is run, the output signal increases by the frame. In this regard, the loop can be called a frame loop. The three preceding steps, S16, S18 and S20, of the frame loop relate to the above-mentioned “analysis” step and the three following steps, S22, S24 and S26, relate to the “synthesis” step. This is explained in more detail as follows.

First, as the first procedure of the “analysis step” as mentioned above, samples consisting of the analysis window Wm are determined from the input signal (step S16). The input signal consisting of a sample stream of an audio signal is segmented by a plurality of successive analysis windows. The m^{th} analysis window Wm consists of the N+Kmax number of samples from the mSa^{th} sample and it is treated as one analysis unit. When the value of the given time-scale α is bigger than 1 (as a case that the playback speed is slower than a normal playback speed, FIG. 3A falls under this case), or when the value of the given time-scale α is smaller than 1 (as a case that the playback speed is faster than a normal playback speed, FIG. 4A falls under this case), the analysis window Wm consists of the always same number, N+Kmax, of samples.

The second procedure of the “analysis” step is to generate the maximum value of cross-correlation between the analysis window Wm and the Nov segment of the output signal and the shift value Km of the analysis window Wm when the maximum value of cross-correlation is provided, with shifting the analysis windows Wm along the output signal within the range of the Kmax number of samples (step S18).

The RCVS-TSM algorithm of the present invention introduces a manner that the amount of computation is greatly reduced in this step. The first method for reducing the amount of computation is to reduce the number of samples participating in computing the maximum value of cross-correlation. The second method for reducing the amount of computation is to extend the shifting interval M₂ of the analysis window Wm. Both or either of the two methods can be applied. It goes without saying that the reduction effect of the amount of computation becomes the greatest when both methods are used.

Cross-correlation computation is made with respect to the samples of the overlapped part 17 of the analysis window Wm and the samples of the overlapped part 17 of the output signal, where the overlapped part 17 has the width capable of including the Nov number of samples. As the output signal is fixed and only the analysis window Wm shifts along the output signal, the part of the output signal participating in the computation of the cross-correlation is always constant to the last Nov number of samples 15 whereas the part of the analysis window Wm participating in the computation of the cross-correlation is changed as it, which consists of Nov number of samples, moves by as many as M₂ samples in the right direction per shift. That is, at first the computation of cross-correlation is performed between a sample segment 10 consisting of the first Nov samples of the analysis window Wm and a sample segment 15 consisting of the last Nov samples of the output signal (refer to FIG. 1A). Then, the analysis window Wm is shifted along the output signal in the left direction by the M₂ number of samples and, at this time, the computation of cross-correlation is again performed between a new sample segment 10 of different Nov samples of the analysis window Wm and the existing sample segment 15 consisting of the Nov samples of the output signal both of which are over the overlapped parts 17. This procedure is repeatedly performed until the total shift value of the analysis window Wm escapes the search range Kmax.

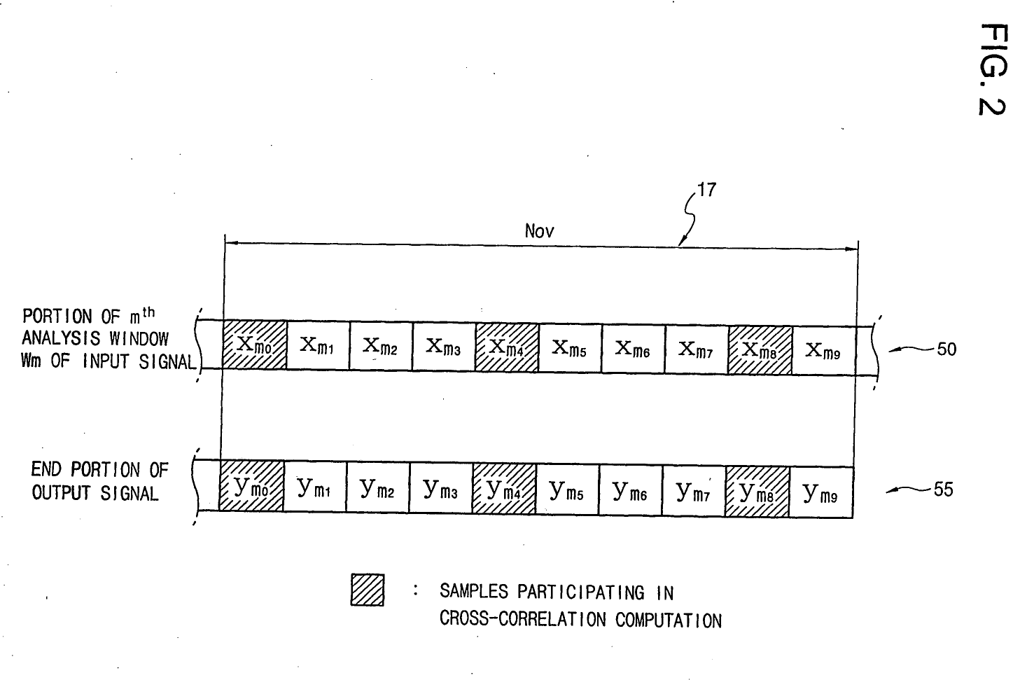

In computing cross-correlations, the present invention takes a particular manner of computing them only with respect to the samples selected from part of, not the whole of, the samples of both the analysis window Wm and the output signal included in the overlapped parts 17. FIG. 2 shows a case as an example that when the overlapped parts 17 consist of 10 samples, the computation of cross-correlation is performed with respect to the samples skipped by the three samples, i.e., between the three samples (xₘ₀, xₘ₄, xₘ₈) selected from the analysis window Wm 50 and the three samples (yₘ₀, yₘ₄, yₘ₈) selected from the output signal 55. The matter as to how much amount of computation will be reduced at which rate can be properly determined taking account of the performance of a processor to which the RCVS-TSM engine of the present invention is applied and the sampling rate of the input signal. The above-mentioned selective computing method that the number of samples participated in computing the cross-correlation are reduced provides less correctness, which is ignorable, in the position providing the best cross-correlation between the analysis window Wm 50 and the output signal 55 than the conventional TSM method which computes the cross-correlation with respect to all samples belonging to the overlapped part Nov.

As the cross-correlation is computed using a sample selected one by one per constant sample intervals M₁ of which value is 2 or larger, not only the actual waveform pattern of the input signal is maintained almost the same, but also the possible maximum error range of the maximum cross-correlation position does not exceed the M₁/2 number of samples. In light of the human hearing ability, noise arisen from this degree of error cannot be perceived and can be ignored.

Together with this, when the certain number which is greater than the natural number 2 is applied as the shift value M₂ of the analysis window Wm, an effect that the amount of computation can be also reduced. It is not necessary to determine the selection interval M₁ and the shift value M₂ the same.

Although the selection interval M₁ and the shift value M₂ can be set to a predetermined value respectively when the RCVS-TSM engine program is coded, they can be determined in one of the following manners. One method is to select one from the two integer values which are the closest values to the value obtained from dividing a real sampling rate of the input signal by a predetermined reference sampling rate and to use the selected value as the selection interval M₁ and/or the shift value M₂. On the premise that the reference sampling rate satisfies the condition that it can properly transfer information of an audio signal, it is preferable that the value of the reference sampling rate is determined as low as possible. Setting it as a high value is against the objective of reducing computation loads of the processor. Considering the function of commercially provided processors, it is not considered problematic that the value of the reference sampling rate is determined at 8 Khz, for example, for use. However, the size of the reference sampling rate will probably be upgraded as the performance of the processor is upgraded in the future. According to this method, the processor can be adjusted to the optimal amount of computation that it can bear without regard to the sampling rate of the input signal. Another method is to predetermine the corresponding value to the selection interval M₁ and/or the shift value M₂ per existing various sampling rates, which is used in real, of the audio signal and apply the corresponding mapping value over the sampling rate known from the header information of the input signal as the selection interval M₁ and/or the shift value M₂.

The above methods of reducing the amount of computation can be widely applied to such TSM methods, searching the optimal overlap length of the analysis window on the basis of cross-correlation, as SOLA, WSOLA and other improved TSM methods that their basic concept is common to SOLA and WSOLA and they are modified and improved for a sound of better quality or the reduction of the amount of computation.

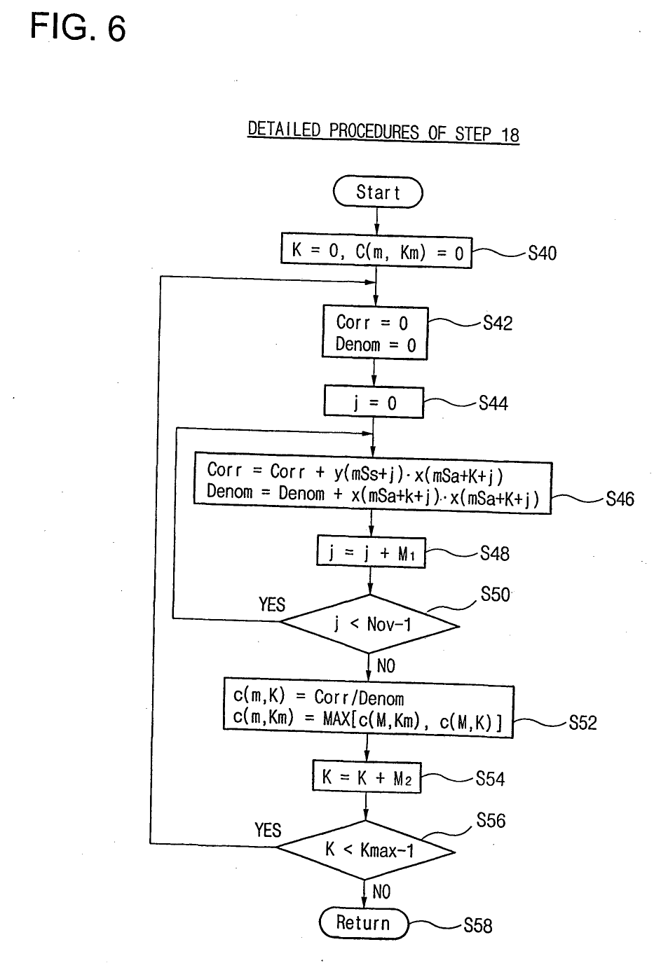

The flow chart of FIG. 6 which is more concretized than the procedures of step S18 is a flowchart of a program to which the above-mentioned methods that reduce the number of samples participating in computing cross-correlation and, at the same time, expand the shifting interval of the analysis window Wm are applied. To compute the best shift Km which is the maximum value of cross-correlation between the analysis window Wm and the output signal and at which the analysis window Wm can be overlap-added to the output signal with the best continuity, parameter K denoting the amount of shifting the analysis window Wm and the parameter C (m, Km) denoting the maximum of the cross-correlation are initialized as 0 (step S40). Also, parameter Corr denoting the cross-correlation, parameter Denom denoting a denominator for standardizing the size of cross-correlation, and parameter j denoting a sample index within the overlapped part 17 are set to 0, respectively (steps S42, S44).

And then, the Corr and the Denom are calculated by using the following equations (step S46) while the sample index j is increased by the selection interval M₁ per cycle (but, M₁ is a natural number bigger than 2) (step S48) until the value exceeds Nov-1 (step S50).
Corr=Corr+x(mSa+j)·y(mSs+K+j) (1)
Denom=Denom+x(mSa+j)·x(mSa+j) (2)

When the computation of the two equations over the whole overlapped part 17 is completed, the standardized cross-correlation c(m, K) is obtained by dividing the value of Corr by the value of Denom. The obtained c(m, K) is compared with the maximum value c(m, Km) among the values of cross-correlation generated so far and the bigger value between the obtained c(m, K) and the maximum value c(m, Km) is thereby determined as the then maximum cross-correlation c(m, Km) (step S52). The above steps (steps S42˜S52) are recursively performed while increasing the value of the parameter K by the shift interval M₂ which is a natural number bigger than 2, until the value of the parameter K does not exceed Kmax-1. When the value of the parameter K becomes bigger than Kmax-1, i.e., when the shifting of the analysis window Wm over the entire search range Kmax has been completed, the value Km providing the then maximum cross-correlation c(m, Km) is the very result that is sought at step S18 and the very shift value of the analysis window Wm to be applied at the time of “synthesis” with respect to the output signal.

Referring to the flow chart of FIG. 6, it is understood that double loop is performed. Unless the above methods of reducing the amount of computation are applied, it can be easily guessed that a huge amount of computation should be performed for the double loop.

On the other hand, after the obtaining of the shift value Km of the analysis window Wm at which the maximum value of cross-correlation between the analysis window Wm and the output signal is provided as above, the RCVS-TSM method of the present invention performs the procedures of determining the optimal overlap length Nm where the best sound can be obtained without distorting the pitch information of the input signal (step S20).

When the optimal shift value Km of the analysis window Wm is sought, the overlapped part 17 between the analysis window Wm and the output signal is applied by the constant length Nov. However, it cannot be said that, in the case that the overlapped part is Nov, the analysis window Wm can always make the best alignment with the output signal. As the optimal shift value Km is just a value which is relatively optimal with respect to the overlapped part in “particular size Nov”, it cannot be said that it is a value which is “absolutely” optimal even in the case that the length of the overlapped part is different. It can be ascertained by an experiment with respect to various kinds of sound sources.

TABLE 1
Rock Music reproduced twice as slow as the reproduction speed of the normal
mode (the threshold value of a coefficient of correlation: 70%)

| | | Nov(1) | Nov(2) | Nov(3) | Nov(4) | Nov(5) |
|---|---|---|---|---|---|---|
| Nov(i) | | 5 msec | 4 msec | 3 msec | 2 msec | 1 msec |
| Coefficient of | Rxy_1 | 100.00 | 100.00 | 100.00 | 100.00 | 100.00 |
| Correlation | Rxy_2 | 37.17 | 39.84 | 54.24 | 84.25 | 66.10 |
| (Rxy_m) | Rxy_3 | 92.80 | 92.80 | 92.80 | 92.80 | 92.80 |
| | Rxy_4 | 100.00 | 100.00 | 100.00 | 100.00 | 100.00 |
| | Rxy_5 | −89.94 | −84.63 | −65.88 | −44.29 | 7.61 |
| | Rxy_6 | 100.00 | 100.00 | 100.00 | 100.00 | 100.00 |
| | Rxy_7 | −58.39 | −33.17 | 22.60 | −15.21 | −25.79 |
| | Rxy_8 | 100.00 | 100.00 | 100.00 | 100.00 | 100.00 |
| | Rxy_9 | 52.50 | 32.36 | 32.53 | 24.64 | 4.62 |
| | Rxy_10 | 71.81 | 71.81 | 71.81 | 71.81 | 71.81 |
| | Rxy_11 | 100.00 | 100.00 | 100.00 | 100.00 | 100.00 |
| | Rxy_12 | 25.28 | 18.93 | 26.89 | 32.38 | 11.15 |
| | Rxy_13 | 39.13 | 41.48 | −6.70 | −8.43 | −24.28 |
| | Rxy_14 | 100.00 | 100.00 | 100.00 | 100.00 | 100.00 |
| | Rxy_15 | 73.21 | 73.21 | 73.21 | 73.21 | 73.21 |
| | Rxy_16 | 84.84 | 84.84 | 84.84 | 84.84 | 84.84 |
| | Rxy_17 | 90.85 | 90.85 | 90.85 | 90.85 | 90.85 |
| | Rxy_18 | 100.00 | 100.00 | 100.00 | 100.00 | 100.00 |
| | Rxy_19 | 76.79 | 76.79 | 76.79 | 76.79 | 76.79 |
| | Rxy_20 | 90.18 | 90.18 | 90.18 | 90.18 | 90.18 |
| | Rxy_21 | 73.41 | 73.41 | 73.41 | 73.41 | 73.41 |
| | Rxy_22 | 88.59 | 88.59 | 88.59 | 88.59 | 88.59 |
| | Rxy_23 | 58.80 | 51.22 | 31.33 | 55.57 | 57.96 |

| | | | | | |
|---|---|---|---|---|---|
| Total | 1,507.01 | 1,508.50 | 1,537.48 | 1,571.40 | 1,539.85 |
| Average | 65.52 | 65.59 | 66.85 | 68.32 | 66.95 |

With respect to a particular segment (23 analysis windows) of rock music data having the characteristic that the frequency bandwidth is relatively wide, table 1 summarizes the results that a coefficient of correlation Rxy between the sample x of the analysis window Wm and the sample y of the output signal is computed per overlapped part, while modifying the length of the overlapped part by various values, i.e., 5 msec, 4 msec, 3 msec, 2 msec, 1 msec and so on.

The coefficient of correlation Rxy is obtained by using the below equation:
Rxy=[(Σxy)/(nσₓσ_{y})]·100% (3)
where n denotes the number of samples of each of parameters x and y both of which are participated in computing the coefficient of correlation and σₓ and σ_{y} denote each dispersion value of the parameters x and y, respectively.

The coefficient of correlation can vary in the range of −100[%] to +100[%]. In general, when the coefficient of correlation between the two parameters x and y has a negative value, there is a so-called negative relationship that the value of one parameter x increases (or decreases) when the value of the other parameter y decreases (or increases). Also, when the coefficient of correlation between the two parameters x and y has a positive value, there is a so-called positive relationship that the parameters are changed in the identical direction. When the value of coefficient of correlation is in the range of 0% to 30%, the correlation between the two parameters x and y is considered weak. When the value is in the range of 30% to 70%, the correlation between the two parameters x and y is considered moderate. When the value is in the range of 70% to 100%, the correlation between the two parameters x and y is considered high. Therefore, if the analysis window is overlap-added to the output signal by applying the value of an overlapped part which cannot provide the coefficient of correlation Rxy between the analysis window and the output signal above 70%, the pitch information of reproduced sound is distorted and the quality of it becomes poor.

As can be ascertained from table 1, the coefficient of correlation does not always become a maximum when the length of the overlapped part is 5 msec. For example, in the case of the second analysis window where the value of the overlapped part is 2 msec, the maximum value 84.25 of the coefficient of correlation is provided. Therefore, the second analysis window can minimize the distortion of pitch information by having the best alignment and signal continuity when the overlapped part, of which the length is 2 msec, is overlap-added to the output signal.

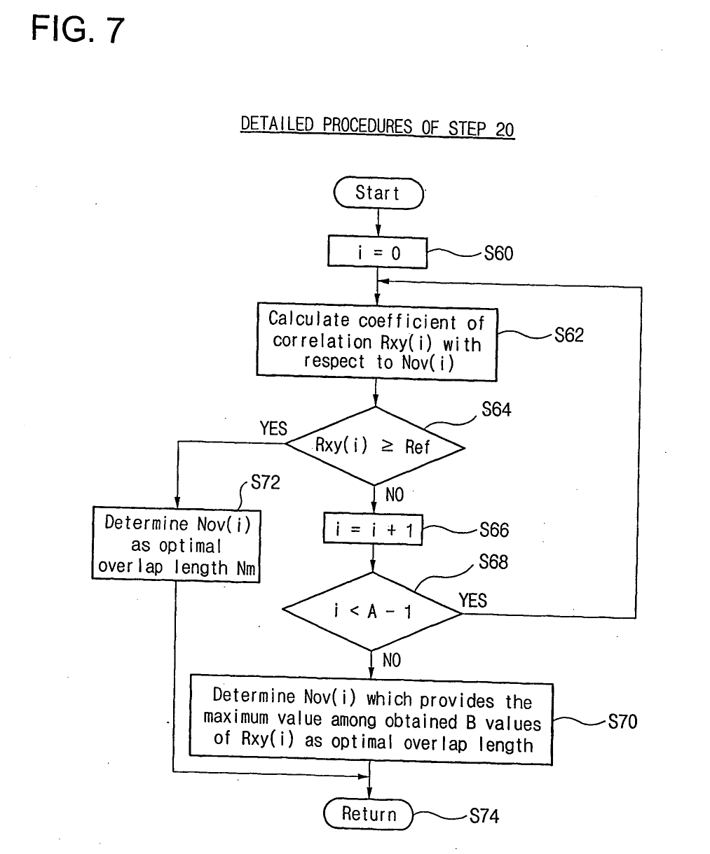

Based upon the above concept, FIG. 7 illustrates detailed procedures of step S20 in which the value of the optimal overlap length Nm is determined per analysis window. Let us assume that the length of the overlapped part is classified into five, i.e., 5 msec, 4 msec, 3 msec, 2 msec, 1 msec, and computations for coefficients of correlation are carried out with varying the length of overlapped part from 1 msec to 5 msec. While increasing the index value i of a candidate overlapped part Nov(i) by one from 0 to 4 (steps S60, S66, S68), the coefficient of correlation Rxy_m(i) with respect to each length of overlapped part is calculated using the above equation (3) (step S62). Then, checked is whether the size of the calculated coefficient of correlation Rxy_m(i) is above a threshold value Ref (step S64).

Although it is preferable that the threshold value is 70%, it can be set to a higher value (for example, 80%) for improving the quality of sound or to a lower value (for example, 60%) for restraining any increase in the amount of computation. Let us assume the case that the threshold value Ref of a coefficient of correlation is set to 70% as in table 1. When the calculated coefficient of correlation Rxy_m(i) has the value above 70%, the value of the then overlapped part Nov(i) is adopted as an optimal overlap length Nm to be applied when the analysis window Wm is actually overlap-added to the output signal (step S72). If the calculated coefficient of correlation Rxy_m(i) does not exceed 70%, the value of i is increased by one (step 66) and then, by calculating the coefficient of correlation Rxy_m(i) with respect to the next overlapped part Nov(i) once again, it is checked whether the value exceeds 70%.

In table 1, in the case that the overlapped part is 5 msec, the coefficients of correlation Rxy_{—}2(0), Rxy_{—}5(0), Rxy_{—}7(0), . . . with respect to the 2^{nd}, 5^{th}, 7^{th}, 9^{th}, 10^{th}, 12^{th}, 13^{th} and 23^{rd} analysis windows are below the threshold value 70%. With respect to each of these analysis windows, the coefficient of correlation Rxy_m(1), where m is 2, 5, 7, 9, 10, 12, 13, 23, is re-calculated when the overlapped part is 4 msec. In the case that the value of the calculated coefficient of correlation is greater than 70%, the optimal overlap length Nm with respect to the analysis window may be determined to 4 msec. In the case that the value of the calculated coefficient of correlation is still less than 70%, the coefficient of correlation Rxy_m(2) is re-calculated when the overlapped part Nov(2) is 3 msec. The coefficients of correlation with respect to the remaining values of the overlapped part are calculated in the above ways. In the case that the coefficient of correlation cannot exceed 70% until its calculation is continued up to the point that the overlapped part is 1 msec, the overlapped part which provides the maximum value among the calculated coefficients of correlation Rxy_m(i) (m is 0, 1, . . . , 4) up to that point is determined as the overlapped part Nm for actual application, that is, the optimal overlap length Nm. In table 1, the optimal overlap length N₄ with respect to the 5^{th} analysis window, for example, is determined to 1 msec.

The RCVS-TSM method of the present invention variably determines the optimal overlap length Nm as described above. In the method although the increase of the amount of computation for searching the optimal overlap length Nm occurs, it cannot be a big problem if the above-explained method of reducing the amount of computation is also applied to the calculation of a coefficient of correlation. In the case of voice having a narrow frequency bandwidth, the concept of the optimal overlap length Nm has a less effect of improving the quality of sound in comparison with the case to which the concept is not applied. However, the effect of improving the quality of sound can be more obtainable in the case that the concept of the optimal overlap length Nm is applied to music having a wide frequency bandwidth than in the case that it is not applied.

Returning to the flow chart of FIG. 5, when the value of the optimal overlap length Nm is determined, an add frame Fm 20 to be overlap-added to the output signal in the corresponding analysis window Wm is determined utilizing the optimal shifting value Km determined at SIB (step S22). In the analysis window Wm, the samples of the region Km˜(Km+N+Nm−Nov) become add frame Fm 20.

Once the add frame Fm 20 is determined, it is overlap-added to the output signal (step S24). The Nm number of samples from the beginning of the add frame Fm 20 and the Nm number of samples from the end of the output signal are overlap-added. In overlap-adding of the add frame 20 and the output signal, both Nm samples of the overlapped parts 35 and 45 of them are synthesized with the application of a weighting function and become an overlap-add block 40 (step S24). The reason that the weighting function is applied to the synthesis is to minimize the discontinuity of the time-scale modified signal in the overlapped part by connecting naturally from the end part of the output signal to the starting part of the add frame Fm 20. The typical example of the weighting function can be the following linear lamp function g(j). Alternatively, an exponential function or any other proper function can be available.

| | | |
|---|---|---|
| g(j) = 0, | j < 0; | (4-1) |
| g(j) = j/Nm, | 0 ≦ j ≦ Nm; | (4-2) |
| g(j) = 1, | j > Nm; | (4-3) |

The Nm number of samples 45 from the end of the output signal is substituted for the newly synthesized overlap-add block 40. The samples except the Nm number of samples 35 from the beginning of the add frame Fm 20 are simply added to the end of the overlap-add block 40 as they are (step S26). The remaining samples of the analysis window Wm, i.e., the Km+Nov−Nm number of samples 30 in the front portion and the Kmax-Km number of samples 25 in the rear portion are abandoned. FIG. 3B shows the case that the length of the input signal is lengthened double when the value of the time-scale α is 2, where the input signal is overlap-added in the above-mentioned manner by utilizing the analysis windows Wm segmented as in FIG. 3A. Variable are the optimal overlap lengths Nm (m=1, 2, 3, . . . ) 60a, 60b, 60c . . . per frame period and the lengths of frames Fm (m=0, 1, 2, 3, . . . ) to be added to the output signal. However, the whole length of the output signal obtained per frame period increases being exactly proportional to the value of a designated time-scale.

The above characteristic is the same as the case that the length of the input signal is shortened. FIG. 4A shows an example that, where the value of time-scale α is 0.5, an input signal is segmented into a plurality of analysis windows Wm (m=1, 2, 3, . . . ) which are successive according to the above-explained analysis window segmenting method. FIG. 4B illustrates that an output signal is synthesized by overlap-adding the analysis windows determined in FIG. 4A applying the best shift Km and the optimal overlap length Nₘ which are determined through the above-mentioned processing of ‘analysis’ and ‘synthesis’. In the case of shortening the length of the input signal, the lengths of frames Fm (m=0, 1, 2, 3, . . . ) which are added per frame period as well as optimal overlap lengths Nₘ (m=1, 2, 3, . . . ) 65a, 65b, 65c, . . . are variable. However, the whole length of the output signal obtained per frame period is shortened being exactly proportional to a designated value of time-scale.

Therefore, the characteristic that the length of the output signal obtained per frame period is lengthened or shortened being exactly proportional to a designated value of time-scale ensures that, where the RCVS-TSM method of the present invention is applied to multi-media reproduction, synchronization between an audio signal and a video signal can be perfectly obtained at any time-scale. For example, in the case of DVD reproduction where a reproduction speed is changed into a slow mode or a fast mode, the reproduction speed for audio can be modified into as exactly same as the reproduction speed for video is modified. Therefore, no matter whether it is a speeding-up reproduction or a slowing-down reproduction, synchronized reproduction of the audio and the video is always possible.

Once “analysis” and “synthesis” processing is passed through with respect to one analysis window as above, one TSM-processed frame is added to an output signal. At this time, to add another TSM-processed frame to the output signal through “analysis” and “synthesis” processing with respect to the next analysis window, the value of frame index m is increased by one (step S28). Then, to check whether there exists an input signal to be processed more, it is checked whether the end of the input signal is met (step S30). If the end of the input signal has not been met, “analysis” and “synthesis” processing is performed with respect to the next analysis window once again. An output signal which is TSM-processed at a desired time-scale can be obtained by repeatedly performing the frame loop as mentioned-above up to the end of the input signal.

The input signal transferred from an input signal provider 88 to an input buffer 82a is time-scale modified into an output signal by being processed by a processor 80 in accordance with the above-explained RCVS-TSM method. The output signal from the processor 80 is successively written in an output buffer 82b by the predetermined unit, and then it is transferred to an audio reproducer 90 and is reproduced in real-time according to a certain output schedule.

### INDUSTRIAL APPLICABILITY

The RCVS-TSM method of the present invention is a new TSM method capable of greatly reducing the amount of computation as compared with the prior TSM methods and also maintaining the quality of sound as same as an original audio signal. When an audio signal having the sampling rate of 192 KHz is TSM-processed by using general SOLA or WSOLA algorithm, the capacity of a processor is required up to the level of about 7,366 MHz. Therefore, it will take long time until a satisfiable CPU, in particular, an embedded processor, of that level is realized as a commercial product and it is impossible to TSM-process an audio signal of a high sampling rate in real-time as above. However, the RCVS-TSM method of the present invention requires a capacity of approximately 28 Mips (approximately 28 KHz) for TSM-processing an audio signal of the sampling rate of 192 KHz in real-time, so that the above-mentioned audio signal of a high sampling rate can be TSM-processed in real-time even in the current commercial CPUs, in particular, such embedded processors.

In improving the quality of sound, the present invention provides better results in comparison with the prior TSM methods. A higher coefficient of correlation is ensured when the overlap length between the analysis window of the input signal and the output signal is variable to an optimal length like the method of the present invention than when it is fixed at a certain length. The present invention can therefore minimize discontinuities of the signal and the resulting distortion of pitch information from time-scale modification.

The RCVS-TSM method of the present invention can be incorporated, by being realized as a program, into the functions of a multimedia player for personal computers or can be applied, by being embedded in chips for such reproducing apparatuses as DVD players, digital VTRs, MP3 players and set-top boxes, to reinforce their function of reproducing a digital audio signal.

While the present invention has been particularly shown and described with reference to particular embodiments thereof, it will be understood by those skilled in the art that various changes and modifications can be made within the scope of the invention as hereinafter claimed. Therefore, all the changes and modifications of which the meaning or scope is equal to the scope of the claims of the present invention belong to the scope of the claims thereof.

1. A method for time-scale modification of an audio signal by which an input signal comprised of an input stream of audio samples is converted into an output signal modified at a desired time-scale, comprising the steps of:
determining an analysis window consisting of a first predetermined number of audio samples in said input stream;
repeating a computation of a similarity between Nov first audio samples of said analysis window and Nov second audio samples of said output signal whenever said analysis window is shifted within a predetermined search range, said similarity being calculated using third and fourth audio sample blocks consisting of audio samples down-selected from said first and second audio samples at a predetermined rate, respectively; and
obtaining a shift value Km of said analysis window when a maximum value of the calculated similarity is provided.

2. A method for time-scale modification of an audio signal as claimed in claim 1, further comprising the step of determining N+Nm−Nov audio samples as an add frame based upon the shift value Km and an optimal overlap length Nm at the time that a coefficient of correlation between said analysis window and said output signal is above a predetermined threshold value or provides a maximum value, said N being a value that a similarity search range Kmax between said analysis window and said output signal is deducted from said first predetermined number.

3. A method for time-scale modification of an audio signal as claimed in claim 2, further comprising the steps of: forming an overlap-add block by weighting Nm audio samples from the beginning of said add frame and Nm audio samples from the end of said output signal with a weighting function; and substituting said overlap-add block for said Nm audio samples from the end of said output signal and adding the rest audio samples of said add frame to the end of said overlap-add block as they are.

4. A method for time-scale modification of an audio signal as claimed in claim 1, wherein said audio samples consisting of said third and fourth audio sample blocks have a difference in sample index as much as M₁ which is a natural number bigger than 2.

5. A method for time-scale modification of an audio signal as claimed in claim 1, wherein said first predetermined number is N+Kmax, where N and Kmax are constants, said search range is a range of Kmax audio samples and said analysis window is regularly shifted by M₂ audio samples per one time shift, where M₂ is a natural number bigger than 2.

6. A method for time-scale modification of an audio signal as claimed in claim 1, wherein said audio samples consisting of said third and fourth audio sample blocks have a difference in a sample index as much as M₁ which is a natural number bigger than 2, said first predetermined number being N+Kmax, where N and Kmax are constants, said search range being a range of Kmax audio samples, and said analysis window being regularly shifted by M₂ audio samples per one time shift, where M₂ is a natural number bigger than 2.

7. A method for time-scale modification of an audio signal as claimed in claim 4, wherein said M₁ being a sample index interval that is, selection interval of the audio samples consisting of said third and fourth audio sample blocks has a value of one of two integers closest to a value obtained by dividing an actual sampling rate of said input signal by a reference sampling rate of a predetermined size.

8. A method for time-scale modification of an audio signal as claimed in claim 4, further comprising the step of preparing corresponding values each of which is mapped into each one of various sampling rates of audio signals in advance and applying a corresponding value mapped at a sampling rate figured out from header information of said input signal as an assigned value of said M₁ being a sample index interval (that is, selection interval of the audio samples consisting of said third and fourth audio sample blocks.

9. A method for time-scale modification of an audio signal as claimed in claim 1, further comprising the step of receiving a value α designated by a user through an input means as said desired time-scale, wherein a length ratio of said output signal to said input signal identical to said value α.

10. A method for time-scale modification of an audio signal as claimed in claim 7, wherein a first audio sample of a m^{th} analysis window is an mSa^{th} audio sample from the beginning of said input stream, and said value Nov being reduced at a predetermined rate by setting N-Ss as a maximum value thereof, where said Ss is a fixed value, and said Sa is determined by a relation of Ss=α Sa.

11. A method for time-scale modification of an audio signal as claimed in claim 1, wherein said similarity is determined by computing a cross-correlation.

12. A method for time-scale modification of an audio signal by which an input signal comprised of an input stream of audio samples is converted into an output signal modified at a desired time-scale, comprising the steps of:
determining an analysis window consisting of N+Kmax audio samples in said input stream, where said N and said Kmax are constants;
while shifting said analysis window within a predetermined search range, computing a maximum value of a similarity between Nov audio samples of said analysis window and Nov audio samples from the end of said output signal and values of coefficient of correlation therebetween with changing said value Nov into various values;
determining N+Nm−Nov audio samples from a Km+Nov−Nm^{th} audio sample from the beginning of said analysis window as an add frame, where said Km is a shift value of said analysis window when said maximum value of said similarity is provided, said Nm being an optimal overlap length when a coefficient of correlation between said analysis window and said output signal is above a predetermined threshold value or provides a maximum value, and said N being a value obtained when N+Kmax is deducted by a similarity search range Kmax between said analysis window and said output signal;
forming an overlap-add block by weighting Nm audio samples of said optimal overlap length from the beginning of said add frame and Nm audio samples of said optimal overlap length from the end of said output signal with a weighting function; and
substituting said overlap-add block for said Nm audio samples of said optimal overlap length from the end of said output signal and simply adding the rest audio samples of said add frame to the end of said overlap-add block.

13. A method for time-scale modification of an audio signal as claimed in claim 12, further comprising the step of receiving a value α designated by a user through an input means as said desired time-scale, wherein a length ratio of said output signal to said input signal identical to said value α.

14. A method for time-scale modification of an audio signal as claimed in claim 12, wherein the first audio sample of a m^{th} analysis window is an mSa^{th} audio sample from the beginning of said input stream, and said value Nov being reduced at a predetermined rate by setting N-Ss as a maximum value thereof, where said Ss is a fixed value, and said Sa is determined by a relation of Ss=α Sa.

15. A method for time-scale modification of an audio signal as claimed in claim 12, wherein said threshold value with respect to said coefficient of correlation is over 0.7.

16. A method for time-scale modification of an audio signal as claimed in claim 12, wherein audio samples participated in computing said similarity and said coefficient of correlation are selected among signals belonging to the respective Nov audio samples of said analysis window and said output signal and adjacent audio samples of said participated audio samples have a difference in sample index as much as M₁ which is a natural number bigger than 2.

17. A method for time-scale modification of an audio signal as claimed in claim 12, wherein said shifting of said analysis window is performed in a manner that said analysis window is regularly shifted by M₂ audio samples per one time shift, where M₂ is a natural number bigger than 2 and the number of shifted audio samples in total is not larger than Kmax audio samples of a search range.

18. A method for time-scale modification of an audio signal as claimed in claim 12, wherein audio samples participated in computing said similarity and said coefficient of correlation are selected among signals belonging to the respective Nov audio samples of said analysis window and said output signal, adjacent audio samples of said participated audio samples having a difference in sample index as much as M₁ which is a natural number bigger than 2, said shifting of said analysis window being performed in a manner that said analysis window is regularly shifted by M₂ audio samples per one time shift, where M₂ is a natural number bigger than 2, and the number of shifted audio samples in total being not larger than Kmax audio samples of a search range.

19. A method for time-scale modification of an audio signal as claimed in claim 16, wherein said parameter M₁ has a value of one of two integers closest to a value obtained by dividing an actual sampling rate of said input signal by a reference sampling rate of a predetermined size.

20. A method for time-scale modification of an audio signal as claimed in claim 12, wherein said similarity between Nov audio samples of said analysis window and Nov audio samples of said output signal is determined by using a cross-correlation or said coefficient of correlation.

21. A method for time-scale modification of an audio signal as claimed in claim 5, wherein said M₂ being a shift interval of said analysis window has a value of one of two integers closest to a value obtained by dividing an actual sampling rate of said input signal by a reference sampling rate of a predetermined size.

22. A method for time-scale modification of an audio signal as claimed in claim 6, wherein said M₁ being a sample index interval, that is, selection interval, of the audio samples consisting of said third and fourth audio sample blocks and said M₂ being a shift interval of said analysis window have a value of one of two integers closest to a value obtained by dividing an actual sampling rate of said input signal by a reference sampling rate of a predetermined size, respectively.

23. A method for time-scale modification of an audio signal as claimed in claim 5, further comprising the step of preparing corresponding values each of which is mapped into each one of various sampling rates of audio signals in advance and applying a corresponding value mapped at a sampling rate figured out from header information of said input signal as an assigned value of said M₂ being a shift interval of said analysis window.

24. A method for time-scale modification of an audio signal as claimed in claim 6, further comprising the step of preparing corresponding values each of which is mapped into each one of various sampling rates of audio signals in advance and applying a corresponding value mapped at a sampling rate figured out from header information of said input signal as an assigned value of said M₁ being a sample index interval, that is, selection interval, of the audio samples consisting of said third and fourth audio sample blocks and/or said M₂ being a shift interval of said analysis window.

25. A method for time-scale modification of an audio signal as claimed in claim 17, wherein said parameter M₂ has a value of one of two integers closest to a value obtained by dividing an actual sampling rate of said input signal by a reference sampling rate of a predetermined size.

26. A method for time-scale modification of an audio signal as claimed in claim 18, wherein said parameter M₁ and said parameter M₂ have a value of one of two integers closest to a value obtained by dividing an actual sampling rate of said input signal by a reference sampling rate of a predetermined size, respectively.
